(19) United States
(12) Patent Application Publication
(10) Pub. No.: US 2011/0069147 A1
(43) Pub. Date: Mar. 24, 2011

(54) PANORAMIC CAMERA, AND SYSTEM AND METHOD FOR MONITORING TARGET PLACES USING THE PANORAMIC CAMERA

(75) Inventors: CHIEN-CHANG LIN, Tu-Cheng (TW); PI-JYE TSAUR, Tu-Cheng (TW)

(73) Assignee: HON HAI PRECISION INDUSTRY CO., LTD., Tu-Cheng (TW)

(21) Appl. No.: 12/690,848

(22) Filed: Jan. 20, 2010

(30) Foreign Application Priority Data
Sep. 18, 2009 (CN) 200910307329.1

(51) Int. Cl. H04N 7/00

(52) U.S. Cl. 348/36; 348/E07.001; 375/240.01; 348/143

(57) ABSTRACT

A panoramic camera, a system, and a method for monitoring target places using the panoramic camera are provided. The system includes a network access server (NAS) connected to the panoramic camera, a video decoder, a computer workstation, and a monitor screen. The panoramic camera captures digital images of a target place from different viewing angles, combines the digital images to create a panoramic image of the target place, encodes and compresses the panoramic image to generate an encoded panoramic image, and transmits the encoded panoramic image to the NAS through a network. When the target place needs to be monitored, the computer workstation obtains the encoded panoramic image from the NAS through a hub. The video decoder decodes the encoded panoramic image to retrieve the panoramic image of the target place. The monitor screen displays the panoramic image to a user for viewing and monitoring the target place.

### BACKGROUND

1. Technical Field

Embodiments of the present disclosure relate generally to cameras and methods for monitoring target places, and more particularly to a panoramic camera, and a system and a method for monitoring target places using the panoramic camera.

2. Description of Related Art

Most cameras only provide a small viewing angle. Thus, a typical conventional camera only captures an image in the direction that the camera is aimed. Limited view cameras force viewers to look only at what the camera operator chooses to focus on. Some cameras use a specialized wide angle lens to capture a wider panoramic image, but such panoramic cameras still have a limited field of view.

At the present time, there are some known methods of creating 360 degree panoramic images. For example, a camera system would capture the scenes from all directions such that a full 360 degree panoramic image can be created. However, most current methods are subject to limitations due to mechanical complexity of the camera system. In one example with respect to FIG. 1, a full 360 degree panoramic image allows multiple cameras (e.g., four cameras 1 positioned at the intersection of a road 2) to simultaneously aim the same place. Then the camera system combines a series of individual photographs taken from different directions into a single panoramic image.

Accordingly, there is a need for a panoramic camera, a system, and a method for monitoring target places using the panoramic camera, so as to overcome the above-mentioned problems.

### BRIEF DESCRIPTION OF THE DRAWINGS

FIG. 1 is a schematic diagram of a traditional camera system.

FIG. 2 is a schematic diagram of one embodiment of interior structure of a panoramic camera.

FIG. 3 is a schematic diagram of one embodiment of exterior structure of the panoramic camera of FIG. 2.

FIG. 4 is a schematic diagram of one embodiment of arrangement of image capturing units inside the panoramic camera of FIG. 3.

FIG. 5 is a schematic diagram of one embodiment of a system for monitoring a target place using the panoramic camera of FIG. 2.

FIG. 6 is a flowchart of one embodiment of a method for monitoring a target place using the panoramic camera of FIG. 2.

FIG. 7 is a schematic diagram illustrating one example of the panoramic camera deployed in a road.

FIG. 8 is a schematic diagram illustrating another example of the panoramic camera deployed at an intersection of two roads.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

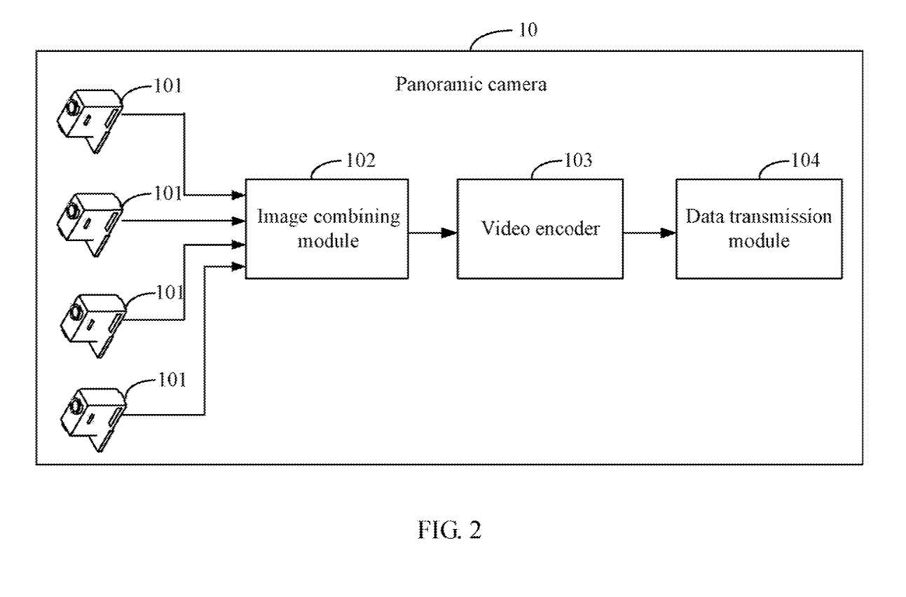

FIG. 2 is a schematic diagram of one embodiment of interior structure of a panoramic camera 10. In one embodiment, the panoramic camera 10 may include a plurality of image capturing units 101, an image combining module 102, a video encoder 103, and a data transmission module 104. It should be apparent that FIG. 2 is only one example of an architecture for the panoramic camera 10 that can be included with more or fewer components than shown, or a different configuration of the various components. In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. The modules described herein may be implemented as either software and/or hardware modules and may be stored in any type of computer-readable medium or other storage device.

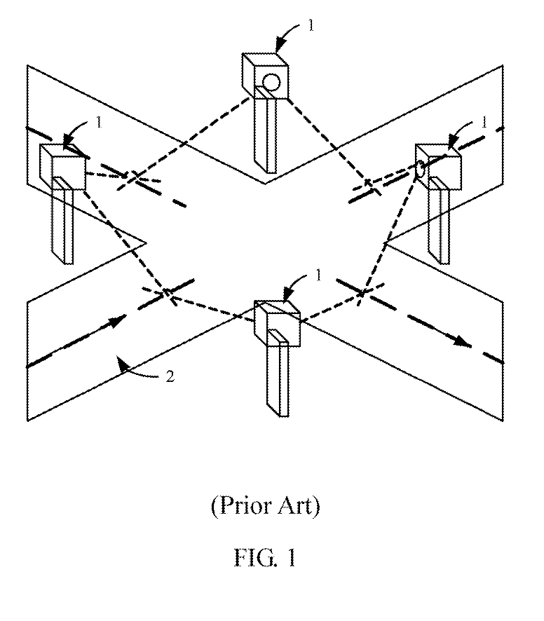

In one embodiment, two or more image capturing units 101 may be embedded in the panoramic camera 10. For example, four image capturing units 101 are shown in FIG. 1, and each of which may be a digital camera, or a video camera. Each of the image capturing units 101 is operable to capture a digital image of a target place from different viewing angles, and send the digital image to the image combining module 102. The target place may be a road, a room, a supermarket, a bank, or any other place to be monitored. The image combining module 102 is operable to combine all of the digital images to create a panoramic image. The video encoder 103 is operable to encode and compress the panoramic image to generate an encoded panoramic image. The data transmission module 104 is operable to transmit the encoded panoramic image to a network storage device through a network, such as 100 Mbyte/1000 Mbyte Ethernet, or any other suitable local area network (LAN).

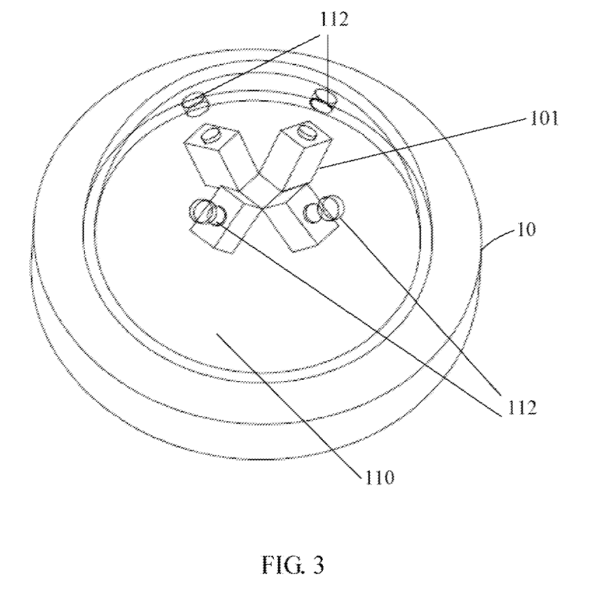

FIG. 3 is a schematic diagram of one embodiment of exterior structure of the panoramic camera 10. In one embodiment, the panoramic camera 10 may be presented in a hemispherical shape, a semi-ellipsoidal shape, or any other suitable shapes. Referring to FIG. 3, the panoramic camera 10 includes a hemispherical shell 110 with a plurality of holes 112 defined on the hemispherical shell 110. The hemispherical shell 110 may be made of bright or semi-bright, and durable materials, such as plexiglass, or plastic materials. Each of the holes 112 corresponds to one of the image capturing units 101, so that each of the image capturing units 101 can capture a digital image of the target place via the hole 112.

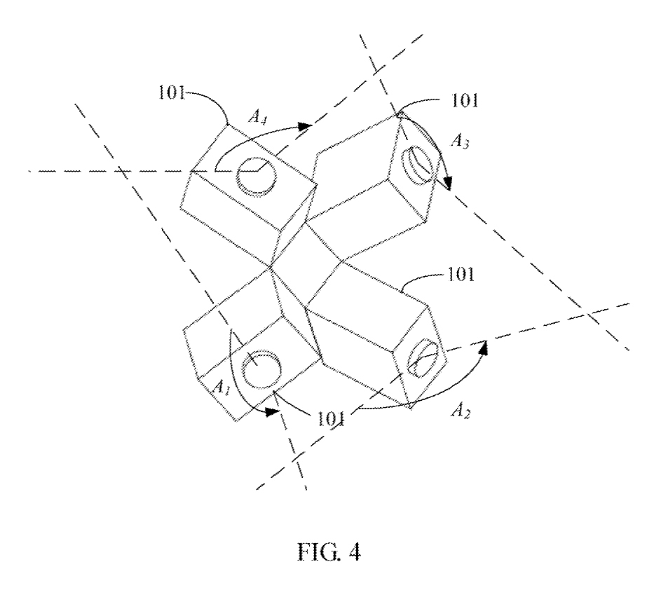

FIG. 4 is a schematic diagram of one embodiment of arrangement of the image capturing units 101 inside the panoramic camera 10. In one embodiment, each of the image capturing units 101 is arranged inside the hemispherical shell 110 in accordance with the equation:

$${\sum }_{i = 1}^{N} {A}_{i} > 360 ° ,$$

here Aᵢ represents a viewing angle of each of the image capturing units 101, such as A₁, A₂, A₃ and A₄ as shown in FIG. 4, and N represents a number of the image capturing units 101, e.g., four image capturing units 101 inside the panoramic camera 10 as shown in FIG. 4. According to the arrangement, each of the image capturing units 101 can capture a digital image of the target place from a viewing angle via a corresponding hole 112.

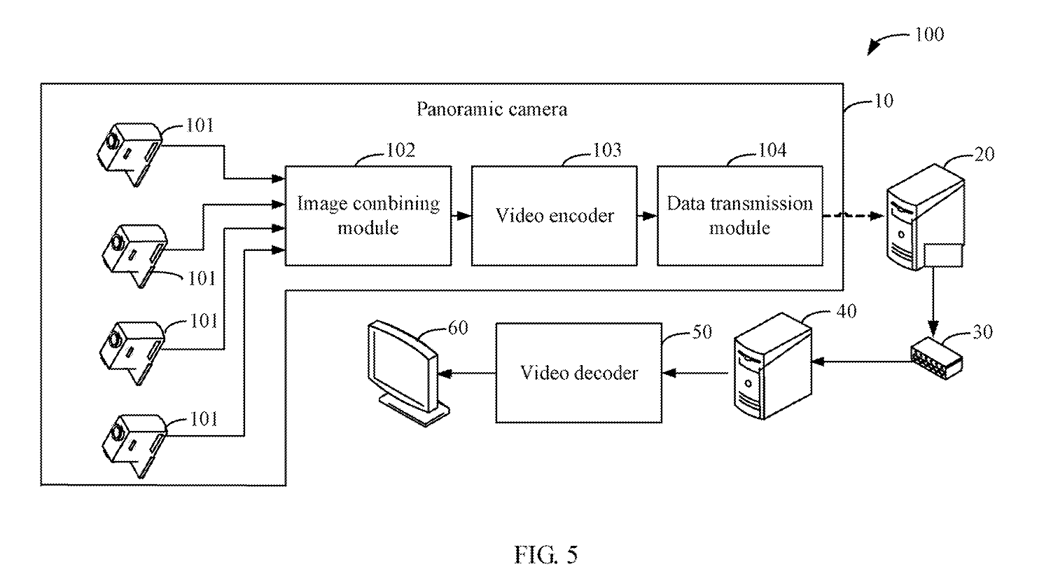

FIG. 5 is a schematic diagram of one embodiment of a monitoring system 100 for monitoring a target place using the panoramic camera 10. In one embodiment, the monitoring system 100 includes the panoramic camera 10, a network access server (NAS) 20, a hub 30, a personal computer (PC) workstation 40, a video decoder 50, and monitor screen 60. The panoramic camera 10 connects to the NAS 20 through a network. The PC workstation 40 connects to the NAS 20 through the hub 30. The monitor screen 60 connects to the PC workstation 40 through the video decoder 50. The panoramic camera 10 may be located at a road, a room, a supermarket, a bank, or any place to be monitored.

The panoramic camera 10 is operable to capture a plurality of digital images of the target place from different viewing angles using each of the image capturing units 101, and combine all of the digital images to create a panoramic image by the image combining module 102. The panoramic camera 10 is further operable to encode and compress the panoramic image to generate an encoded panoramic image by the video encoder 103, and transmit the encoded panoramic image to the NAS 20 for storing the encoded panoramic image through the network.

The NAS 20 is operable to receive the encoded panoramic image from the panoramic camera 10, and store the encoded panoramic image. The PC workstation 40 is operable to obtain the encoded panoramic image from the NAS 20 through the hub 30 and send the encoded panoramic image to the video decoder 50 when the target place needs to be monitored. The video decoder 50 is operable to decode the encoded panoramic image to retrieve the panoramic image of the target place. The monitor screen 60 is operable to display the panoramic image to a user for viewing and monitoring the target place.

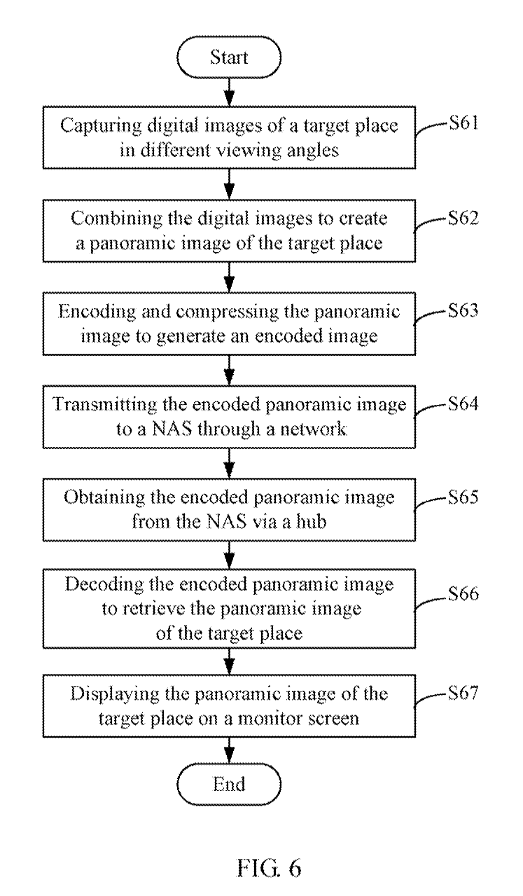

FIG. 6 is a flowchart of one embodiment of a method for monitoring an target place using the panoramic camera 10.

In block S61, each of the image capturing units 101 captures a digital image of the target place from different viewing angles, and sends the digital image to the image combining module 102. In one embodiment, four image capturing units 101 are embedded in the panoramic camera 10, and each of which may be a digital camera, or a video camera, for example. The image capturing units 101 are arranged inside the panoramic camera 10 in accordance with the equation:

$${\sum }_{i = 1}^{N} {A}_{i} > 360 ° ,$$

here Aᵢ represents a viewing angle of each of the image capturing units 101, such as A₁, A₂, A₃ and A₄ as shown in FIG. 4.

In block S62, the image combining module 102 combines all of the digital images to generate a panoramic image. In block S63, the video encoder 103 encodes and compresses the panoramic image to generate an encoded panoramic image. In one embodiment, the video encoder 103 encodes the panoramic image by using a traditional encoding technique, such as an MPEG-4 encoder, or an H.264 encoder, for example.

In block S64, the data transmission module 104 transmits the encoded panoramic image to the NAS 20 through a network, such as 100 Mbyte/1000 Mbyte Ethernet, or any other suitable local area network (LAN). The NAS 20 stores the encoded panoramic image when the NAS 20 receives the encoded panoramic image from the panoramic camera 10 to retrieve a panoramic image of the target place when a user needs to view or monitor the target place.

In block S65, the PC workstation 40 obtains the encoded panoramic image from the NAS 20 through the hub 30 when the user needs to view or monitor the target place, and sends the encoded panoramic image to the video decoder 50. In block S66, the video decoder 50 decodes the encoded panoramic image to retrieve the panoramic image of the target place. In block S67, the monitor screen 60 displays the panoramic image to the user for viewing and monitoring the target place.

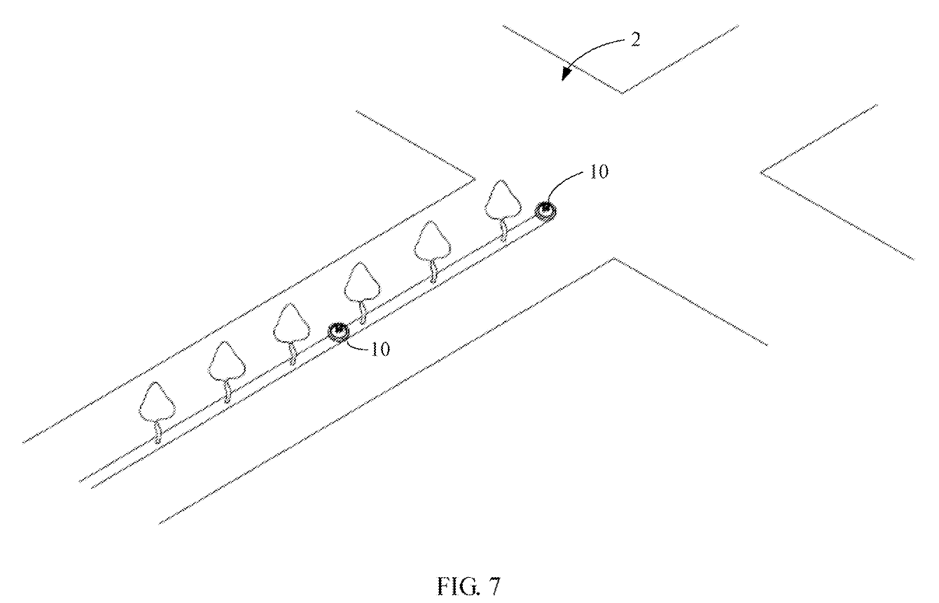

FIG. 7 is a schematic diagram illustrating one example of two panoramic cameras 10 deployed at the center of a road 2. Depending on the example, the two panoramic cameras 10 are located at the center of the road 2, and create different panoramic image of the road 2. Thereby, the user can monitor the traffic status of the road 2 by viewing the different panoramic images on the monitor screen 60.

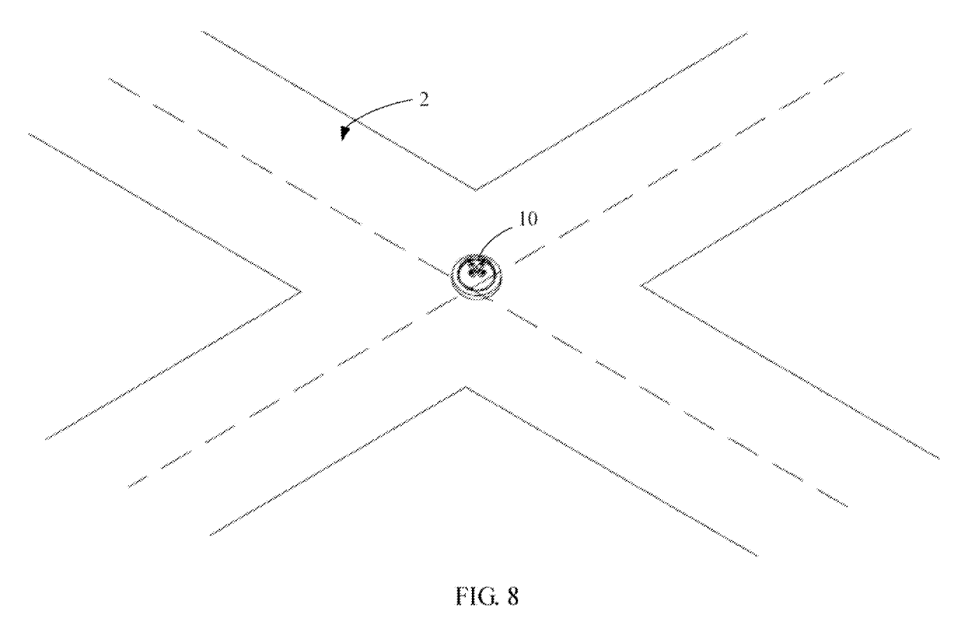

FIG. 8 is a schematic diagram illustrating another example of the panoramic camera 10 deployed at an intersection of two roads 2. Depending on the example, the panoramic camera 10 is located at the intersection of the two roads 2, and creates different panoramic images of the two roads 2. Thereby, the user can monitor the traffic status of the intersection of the two roads 2 by viewing the different panoramic images on the monitor screen 60.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A panoramic camera, comprising:
a plurality of image capturing units operable to capture digital images of a target place from different viewing angles;
an image combining module operable to combine the digital images to create a panoramic image of the target place;
a video encoder operable to encode and compress the panoramic image to generate an encoded panoramic image; and
a data transmission module operable to transmit the encoded panoramic image to a network storage device for storing the encoded panoramic image.

2. The panoramic camera according to claim 1, wherein the panoramic camera further comprises a hemispherical shell with a plurality of holes defined on the surface of the hemispherical shell.

3. The panoramic camera according to claim 2, wherein each of the image capturing units corresponds to one of the holes, and captures a digital image of the target place from a viewing angle via the corresponding hole.

4. The panoramic camera according to claim 2, wherein the hemispherical shell is made of bright or semi-bright, and durable materials.

5. The panoramic camera according to claim 1, wherein the image capturing units are arranged inside the panoramic camera in accordance with an equation:
$${\sum }_{i = 1}^{N} {A}_{i} > 360 ° ,$$
herein Aᵢ represents a viewing angle of each of the image capturing units, and N represents a number of the image capturing units.

6. A method for monitoring a target place using a panoramic camera, the method comprising:
capturing a plurality of digital images of the target place from different viewing angles;
combining all of the digital images to create a panoramic image;
encoding and compressing the panoramic image to generate an encoded panoramic image;
transmitting the encoded panoramic image to a network access server (NAS) through a network;
storing the encoded panoramic image when the NAS receives the encoded panoramic image;
obtaining the encoded panoramic image from the NAS through a hub when the target place needs to be monitored, and sending the encoded panoramic image to a video decoder;
decoding the encoded panoramic image via the video decoder to retrieve the panoramic image of the target place; and
displaying the panoramic image of the target place on a monitor screen.

7. The method according to claim 6, wherein the panoramic camera comprises a plurality of image capturing units, a hemispherical shell with a plurality of holes defined on the surface of the hemispherical shell.

8. The method according to claim 7, wherein each of the image capturing units corresponds to one of the holes, and captures a digital image of the target place from a viewing angle via the corresponding hole.

9. The method according to claim 7, wherein the hemispherical shell is made up bright or semi-bright, and durable materials.

10. The method according to claim 7, wherein the image capturing units are arranged inside the panoramic camera in accordance with an equation:
$${\sum }_{i = 1}^{N} {A}_{i} > 360 ° ,$$
herein Aᵢ represents a viewing angle of each of the image capturing units, and N represents a number of the image capturing units.

11. The method according to claim 6, wherein the panoramic camera is located at an intersection of roads to monitor a traffic status of the intersection of the roads by creating different panoramic images of the roads.

12. The method according to claim 6, wherein the panoramic camera is located at the center of a road to monitor a traffic status of the road by creating different panoramic images of the road.

13. A system for monitoring a target place, the system comprising:
a panoramic camera operable to capture a plurality of digital images of an target place from different viewing angles, combine the digital images to create a panoramic image of the target place, encode and compress the panoramic image to generate an encoded panoramic image, and transmit the encoded panoramic image to a network storage device through a network;
a network access server (NAS) operable to receive the encoded panoramic image from the panoramic camera, and store the encoded panoramic image;
a computer workstation operable to obtain the encoded panoramic image from the NAS through a hub when the target place needs to be monitored;
a video decoder operable to receive the encoded panoramic image from the computer workstation, and decode the encoded panoramic image to retrieve the panoramic image of the target place; and
a monitor screen operable to display the panoramic image to a user for viewing and monitoring the target place.

14. The system according to claim 13, wherein the panoramic camera comprises a plurality of image capturing units, and a hemispherical shell with a plurality of holes defined on the surface of the hemispherical shell.

15. The system according to claim 14, wherein each of the image capturing units corresponds to one of the holes, and captures a digital image of the target place in a viewing angle via the corresponding hole.

16. The system according to claim 14, wherein the hemispherical shell is made up bright or semi-bright materials, and durable materials.

17. The system according to claim 14, wherein the image capturing units are arranged inside the panoramic camera in accordance with an equation:
$${\sum }_{i = 1}^{N} {A}_{i} > 360 ° ,$$
herein Aᵢ represents a viewing angle of each of the image capturing units, and N represents a number of the image capturing units.

18. The system according to claim 13, wherein the panoramic camera is located at a road, a room, a supermarket, a bank, or any place to be monitored.
